(19) United States
(12) Patent Application Publication
(10) Pub. No.: US 2015/0168222 A1
(43) Pub. Date: Jun. 18, 2015

(54) INFRARED DETECTION DEVICE

(71) Applicant: Panasonic Intellectual Property Management Co., Ltd., Osaka (JP)

(72) Inventor: Toshinari Noda, Osaka (JP)

(73) Assignee: Panasonic Intellectual Property Management Co., Ltd., Osaka (JP)

(21) Appl. No.: 14/404,492

(22) PCT Filed: Jun. 7, 2013
(86) PCT No.: PCT/JP2013/003596

§ 371 Date: Nov. 28, 2014

(30) Foreign Application Priority Data
Jun. 18, 2012 (JP) 2012-136600

(51) Int. Cl. G01J 5/34

(52) U.S. Cl. CPC G01J 5/34

(57) ABSTRACT

An infrared detection device includes a substrate and a heat-type light sensing element. The substrate has a recess, and a frame positioned around the recess. The heat-type light sensing element has a leg and a sensing unit, and the leg is connected onto the frame so that the sensing unit is positioned over the recess. The heat-type light sensing element includes an intermediate layer provided on the substrate, a first electrode layer provided on the intermediate layer, a sensing layer provided on the first electrode layer, and a second electrode layer provided on the sensing layer. The substrate has a linear thermal expansion coefficient larger than that of the sensing layer. The intermediate layer has a linear thermal expansion coefficient decreasing toward the first electrode layer from the substrate.

### TECHNICAL FIELD

The present invention relates to an infrared detection device determining electrical properties that change according to temperature rise caused by receiving infrared rays and to a method of producing the infrared detection device.

### BACKGROUND ART

As a sensor device that senses temperature in a noncontact manner, an infrared detection device that is a heat-type using infrared rays has been devised up to now. Examples of a heat-type infrared detection device include a pyroelectric detecting device, resistance bolometer detecting device, and thermopile detecting device. A pyroelectric detecting device employs a pyroelectric material that generates electric charge on its surface due to temperature change. A resistance bolometer detecting device employs a resistance bolometer material that changes its resistance value due to temperature change. A thermopile detecting device uses the Seebeck effect in which a thermoelectromotive force is generated due to temperature difference.

Among them, a pyroelectric detecting device has differential output characteristics that produce output due to the change of the amount of incoming infrared rays. Thus, pyroelectric detecting devices are widely used for a sensor for sensing movement of a heat-generating object such as a person and animal for instance.

Typical examples of a pyroelectric detecting device include a single-element or dual-element detecting device using bulk ceramics (e.g., PLT 1). In a dual-element detecting device, the electrodes on the photo-reception surface or on the counter-face surface of two single elements are connected together in series so that electric charges generated by temperature change of the pyroelectric substrate have opposite polarities from each other. This structure allows correcting external temperature dependence produced when only one single element is used. Further, through the use of a feature in which the phase of an output waveform reverses depending on a moving direction of a human body, the direction can be determined by which of positive side or negative side human body sense signal has been output first.

A previous pyroelectric detecting device, however, is almost unable to minutely sense two-dimensional behavior of a person or to accurately sense the temperature distribution in a space. Hence, a method is devised in which a pyroelectric thin film formed on a silicon substrate is processed in an array by a semiconductor micromachining process for multi-pixelization (e.g., PLT 2).

FIGS. 6, and 7 illustrate the element structure of a conventional array-type infrared detection device. FIG. 6 is a perspective view of the conventional array-type infrared detection device and FIG. 7 is a sectional view thereof.

The conventional array-type infrared detection device is composed of heat sensing element 21, film 201 on which at least one additional heat sensing element 22 is formed, and substrate 200 made of silicon. Heat sensing elements 21 and 22 are provided on surface 202 of film 201 as a heat sensing element array. FIG. 6 illustrates an array-type infrared detection device having heat sensing elements 21 and 22 arranged in a matrix of 2 by 2.

As shown in FIG. 7, each of heat sensing elements 21 includes electrode layers 212 and pyroelectric layer 213 placed between electrode layers 212 and each of heat sensing elements 22 includes electrode layers 222 and pyroelectric layer 223 placed between electrode layers 222. Pyroelectric layers 213 and 223 are formed of PZT as a pyroelectric sensing material and have a thickness of approximately 1 μm. Electrode layers 212 and 222 are formed of platinum and a chrome-nickel alloy, for instance, with a thickness of approximately 20 nm. Film 201 is composed of three layers: Si₃N₄, SiO₂, and Si₃N₄. Note that a read circuit (not shown) is formed in substrate 200.

Thin interlink net 204 made of silicon is formed on surface 202 of film 201 and on its back surface opposite to surface 202. Interlink net 204 is formed between heat sensing elements 21 and 22. Interlink net 204 is formed so as to extend from at least one of heat sensing elements 21 and 22 to one heat sink. Further, film 201 is provided with slits 205 formed therein. Slits 205 function as adjusting devices for adjusting respective heat flows.

### CITATION LIST

### Patent Literature

PTL 1: WO 2011/001585A

PTL 2: Japanese Translation of PCT Publication No. 2010-540915

### SUMMARY OF THE INVENTION

The present invention provides a highly sensitive infrared detection device with high pyroelectric characteristics and very high heat insulation. The infrared detection device of the present invention includes a substrate and a heat-type light sensing element. The substrate is provided with a recess (cavity), and has a frame positioned around the recess. The heat-type light sensing element has a leg and a sensing unit, and the leg is connected onto the frame so that the sensing unit is positioned over the recess. The heat-type light sensing element also includes an intermediate layer provided on the substrate, a first electrode layer provided on the intermediate layer, a sensing layer provided on the first electrode layer, and a second electrode layer provided on the sensing layer. The substrate has a linear thermal expansion coefficient larger than that of the sensing layer. The intermediate layer has a linear thermal expansion coefficient decreasing toward the first electrode layer from the substrate.

As described above, the substrate with a linear thermal expansion coefficient larger than that of the sensing layer allows a compressive stress to be applied to the sensing layer owing to thermal stress. This provides high infrared detectability. Further, the intermediate layer has a linear thermal expansion coefficient decreasing toward the first electrode layer from the substrate, which prevents warpage and destruction of the sensing layer even in an infrared detection device that supports the sensing layer with a thin leg and has high heat insulation. This allows producing an infrared detection device with high infrared detectability.

### BRIEF DESCRIPTION OF DRAWINGS

FIG. 1A is a top view of an infrared detection device according to an embodiment of the present invention.

FIG. 1B is a sectional view of the infrared detection device shown in FIG. 1A.

FIG. 2 illustrates an X-ray diffraction pattern of a sensing layer in the infrared detection device shown in FIG. 1B.

FIG. 3 illustrates the characteristics of the sensing layer shown in

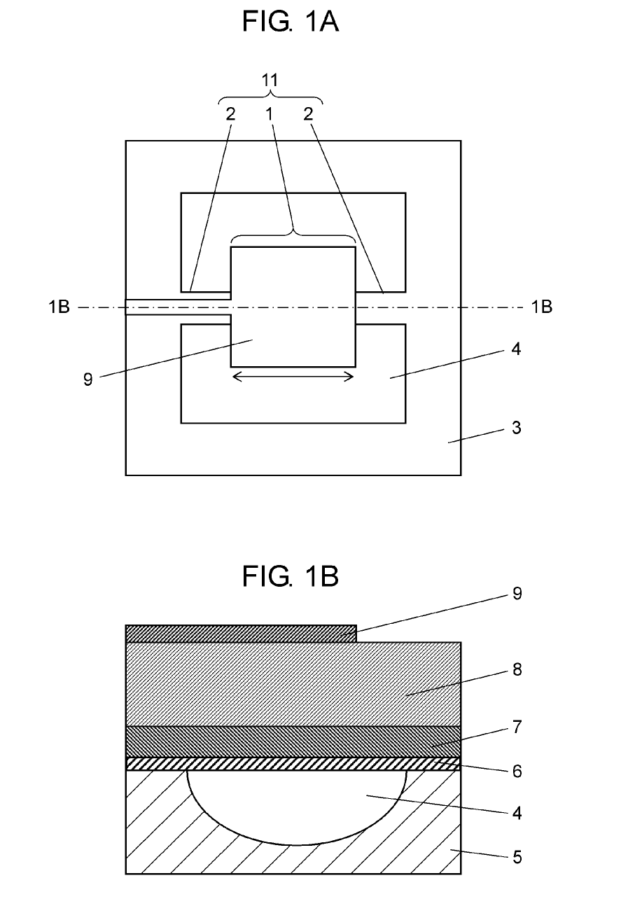

FIG. 1B.

FIG. 4A is a top view of another infrared detection device according to the embodiment of the present invention.

FIG. 4B is a sectional view of the infrared detection device shown in FIG. 4A.

FIG. 5A is a top view of yet another infrared detection device according to the embodiment of the present invention.

FIG. 5B is a sectional view of the infrared detection device shown in FIG. 5A.

FIG. 6 is a perspective view of a conventional infrared detection device.

FIG. 7 is a sectional view of the infrared detection device shown in FIG. 6.

### DESCRIPTION OF EMBODIMENTS

Prior to the description of an embodiment of the present invention, a description is made of some disadvantages in the conventional infrared detection device. The array-type infrared detection device shown in FIG. 6 includes substrate 200 made of silicon with a smaller linear thermal expansion coefficient, and pyroelectric layers 213 and 223 provided on substrate 200 and made of PZT with a larger linear thermal expansion coefficient. Accordingly, the detection device has low pyroelectric characteristics. Meanwhile, all of the four sides of pyroelectric layer 213 are in contact with substrate 200 made of silicon with very high heat conductivity via film 201. Accordingly, heat generated in pyroelectric layer 213 by receiving infrared rays easily escapes.

Hereinafter, a description is made of the embodiment using the related drawings. FIG. 1A is a top view of the outline structure of an infrared detection device according to the embodiment of the present invention. FIG. 1B is a sectional view of the device shown in FIG. 1A, taken along line 1B-1B.

This infrared detection device includes substrate 5 and heat-type light sensing element 11. Substrate 5 is provided with recess 4, and has frame 3 positioned around recess 4. Heat-type light sensing element 11 has leg 2 and sensing unit 1, and leg 2 is connected onto frame 3 so that sensing unit 1 is positioned over recess 4. Heat-type light sensing element 11 also includes intermediate layer 6 provided on substrate 5 and above recess 4, first electrode layer 7 provided on intermediate layer 6, sensing layer 8 provided on first electrode layer 7, and second electrode layer 9 provided on sensing layer 8. Substrate 5 has a linear thermal expansion coefficient larger than that of sensing layer 8. Intermediate layer 6 has a linear thermal expansion coefficient deceasing toward first electrode layer 7 from substrate 5.

Next, a detailed description is made of each component. Substrate 5 is provided with recess 4 in at least one main surface. At least one leg 2 extends from the main surface (frame 3) of substrate 5 surrounding recess 4 to over recess 4. Sensing unit 1 is suspended and supported over recess 4 by leg 2.

Heat-type light sensing element 11 is structured to have high heat insulation against frame 3 by being provided with recess 4. Note that recess 4 may be provided in any way as long as it is deep enough to support sensing unit 1 with leg 2 in midair over substrate 5. Therefore, recess 4 may penetrate substrate 5 or may be bottomed as shown in FIG. 1B.

Leg 2 has at least intermediate layer 6, first electrode layer 7, and sensing layer 8, in this order from the main surface of substrate 5. Sensing unit 1 has the same structure as leg 2 and further has second electrode layer 9 on sensing layer 8. Note that at least one leg 2 is provided with second electrode layer 9 on sensing layer 8, and the same layers are linked together through leg 2 and sensing unit 1.

The material of substrate 5 has a linear thermal expansion coefficient larger than that of the material of sensing layer 8. Example of the material of substrate 5 include a metallic material such as stainless steel primarily containing iron and chrome, titanium, aluminum, and magnesium; a glass-based material such as borosilicate glass; a single-crystal material such as magnesium oxide and fluorinated calcium; and a ceramic material such as titania and zirconia. A metallic material that reflects infrared rays is particularly effective.

Alternatively, the material of substrate 5 may be a metal steel strip (a rolled steel plate) that has undergone rolling. The metal steel strip is preferably formed of an aggregate of minute metal particles in a metallic structure (represented by austenite or martensite, for instance). In other words, substrate 5 is preferably formed of a rolled steel plate having a minute metallic structure. When sensing layer 8 is square in the top view as shown in FIG. 1A, the diameter of the metallic structure is preferably smaller than the short side of sensing layer 8. Besides, when sensing layer 8 is circular (not shown) in the top view, the diameter of the metallic structure is preferably smaller than the diameter of sensing layer 8. This structure allows increasing the speed of machining for etching substrate 5 as described later, which eventually shorten the takt time for manufacturing infrared detection devices.

Intermediate layer 6 is made of silicon oxide or a compound material containing silicon oxide. For example, silicon oxide or a silicon nitride film (SiON) that is produced by nitriding silicon oxide can be used for intermediate layer 6.

Intermediate layer 6 has at least two types of elements contained in substrate 5 diffusing therein, where the diffusion amount (density) of these elements are inclined (i.e., decreased) from substrate 5 toward first electrode layer 7. When stainless steel is used for substrate 5, the elements diffusing in intermediate layer 6 are iron and chrome. In intermediate layer 6, the diffusion coefficients of the iron and chrome are different from each other, where the chrome with a larger diffusion coefficient results in a larger diffusion amount. That is, in intermediate layer 6, the gradients of the diffusion amount of the two types or more of elements contained in substrate 5 are different from each other. Thus in intermediate layer 6, the iron and chrome result in different ratios of the diffusion amount. Consequently, the iron has a larger ratio near substrate 5, and thus the linear thermal expansion coefficient is larger near substrate 5 and is decreased toward first electrode layer 7. Such arrangement prevents warpage of substrate 5 and intermediate layer 6 due to thermal stress resulting from the difference in the linear thermal expansion coefficient between substrate 5 and intermediate layer 6. Accordingly, even in a state where intermediate layer 6 is separated from the surface of substrate 5, warpage and destruction of sensing unit 1 and leg 2 can be prevented.

Further, even in a region where recess 4 is formed in the surface of substrate 5, warpage of intermediate layer 6 and the layers formed thereon due to residual stress can be prevented. This provides an infrared detection device with high heat insulation. Note that, when choosing elements other than iron and/or chrome as elements diffused in intermediate layer 6, only its linear thermal expansion coefficient and diffusion coefficient need to be considered as described above. A combination of the following two types of elements provides the same advantage. One has a relatively large linear thermal expansion coefficient and easily diffuses. The other has a small linear thermal expansion coefficient and hardly diffuses.

First electrode layer 7 is formed of nickel oxide lanthanum (LaNiO₃, described as LNO hereafter), or a material with part of the nickel in LNO replaced with another metal. LNO has space group R-3c and a perovskite structure distorted in a rhombohedron (rhombohedral system: a₀=0.5461 nm (a₀=aₚ), α=60°, pseudo-cubic system: a₀=0.384 nm). The LNO has a resistivity of 1×10⁻³ (Ω·cm, 300 K), which means the LNO is an oxide with metallic electric conductivity. Furthermore, temperature change does not cause transition between the metal and an electric insulator.

Examples of a material produced by replacing part of the nickel in the LNO with another metal include a LaNiO₃—LaFeO₃-based material replaced with iron, LaNiO₃—LaAlO₃-based material replaced with aluminum, LaNiO₃—LaMnO₃-based material replaced with manganese, and LaNiO₃—LaCoO₃-based material replaced with cobalt. A material replaced with two or more types of metals can be used as required.

For first electrode layer 7, various types of conductive oxide crystal substances can be used besides LNO. Such examples include a perovskite oxide of a pseudo-cubic system, preferentially oriented to (100) plane, primarily containing strontium ruthenate, lanthanum-strontium-cobalt oxide or the like.

Sensing layer 8 is formed of a material that changes its polarization amount or capacitance according to temperature change. For example, sensing layer 8 is formed of lead zirconate titanate (PZT) with (001) plane orientation of a rhombohedral system or tetragonal system. The PZT desirably has a composition (Zr/Ti=30/70) near the composition of a tetragonal system, but may have a composition (Zr/Ti=53/47) near the phase boundary (morphotropic phase boundary) between a tetragonal system and a rhombohedral system, or PbTiO₃ may be used, as long as Zr/Ti=0/100 to 70/30 is satisfied. The constituent material of sensing layer 8 may be any perovskite oxide ferroelectric substance that primarily contains PZT, such as PZT containing an additive such as La, Ca, Sr, Nb, Mg, Mn, Zn, or Al. That is, the constituent material may be PN (Pb(Mg_{1/3}Nb_{2/3})O₃) or PZN (Pb(Zn_{1/3}Nb_{2/3})O₃).

Here, the PZT of a tetragonal system used in this embodiment is a material having a lattice constant of a=b=0.4036 nm, c=0.4146 nm in the value of bulk ceramics. Hence, LNO of a pseudo-cubic structure having a lattice constant of a=0.384 nm provides favorable lattice matching to (001) and (100) planes of the PZT.

The term “lattice matching” refers to lattice matching between a unit lattice of PZT and a unit lattice of LNO. It has been reported that, in general, when a crystal plane is exposed to a surface of the crystal, the crystal lattice of the crystal and the crystal lattice of a film to be formed on the crystal are promoted to match each other, thereby easily forming an epitaxial crystal nuclei at the boundary.

Note that, if the difference between the lattice constant of (001) and (100) planes of sensing layer 8 and the lattice constant of the main orientation plane of first electrode layer 7 falls within roughly 10% in absolute value, the crystal orientation of either one of (001) or (100) plane of sensing layer 8 can be increased. In other words, it is preferable that first electrode layer 7 be formed of a conductive perovskite oxide and the ratio of the difference between the lattice constant of the main orientation plane of first electrode layer 7 and the lattice constant of the main orientation plane of sensing layer 8 with respect to the lattice constant of the main orientation plane of sensing layer 8 be ±10% or less.

Note that, in orientation control by lattice matching, it is difficult to achieve a film selectively oriented to (001) or (100) plane. Hence, as described later, when sensing layer 8 is formed, a compressive stress is applied to sensing layer 8, namely sensing layer 8 is compressed toward the inside of the plane, which allows the orientation to be controlled selectively to (001) plane.

By producing LNO by the manufacturing method described later, a film preferentially oriented to (100) plane can be formed on various types of substrates. Hence, the LNO works as first electrode layer 7 and also as an orientation control layer for sensing layer 8. This produces selectively (001) or (100) plane of PZT (lattice constant: a=0.4036 nm, c=0.4146 nm) that provides favorable lattice matching to the surface (lattice constant: 0.384 nm) of LNO oriented to (100) plane.

Meanwhile, first electrode layer 7 using a conductive oxide material such as LNO has a lower heat conductance than a conventional case where platinum is used. That is, the heat insulation of sensing unit 1 is increased and eventually the sensitivity of heat-type light sensing element 11 is increased.

Second electrode layer 9 is formed of a nichrome (Ni—Cr) material and is approximately 20 nm thick, for instance. Nichrome has electrical conductivity as well as high infrared absorption ability among metal-based materials. Second electrode layer 9 may be made of any material that has electrical conductivity and infrared absorption ability with a thickness between 10 nm and 500 nm. Besides titanium or titanium alloy, a conductive oxide such as LNO, ruthenium oxide, or strontium ruthenium oxide may be used. Alternatively, a metal black film what is called a platinum black film or a gold black film may be used that is produced by controlling the crystal particle diameter of platinum or gold to add infrared absorption ability.

Note that, as described above, substrate 5 has a linear thermal expansion coefficient larger than that of sensing layer 8. In the process of forming a film of sensing layer 8 described later, an annealing process is required when forming the film. PZT, crystallized and rearranged at a high temperature, generates residual stress due to the difference in linear thermal expansion coefficient from that of substrate 5 when cooled to the room temperature. When substrate 5 is formed of SUS430 for instance, SUS430 has a linear thermal expansion coefficient of 10.5 ppm/K while PZT 7.9 ppm/K. Thus, substrate 5 formed of SUS430 has a linear thermal expansion coefficient larger than that of sensing layer 8 formed of PZT. Accordingly, PZT undergoes a compressive stress, resulting in sensing layer 8 having highly selective orientation in the direction of c axis i.e., the direction of the polarization axis. Note that SUS430 is a ferrite-based stainless steel, contains no Ni, and contains Cr from 16 wt % to 18 wt %.

It is known that infrared detectability of sensing layer 8 is proportional to its pyroelectric coefficient, which exhibits a high value in a film oriented in the direction of the polarization axis of the crystal. As described above, sensing layer 8 is formed on substrate 5 with a large linear thermal expansion coefficient, and the film has undergone a compressive stress due to a thermal stress during a film-forming process. Consequently, sensing layer 8, oriented in the direction of c axis which is the polarization axis, has high infrared detectability.

Additionally, applying a compressive stress to sensing layer 8 owing to a thermal stress from substrate 5 increases the Curie point of sensing layer 8. For example, sensing layer 8 formed on a Si substrate has a Curie point of approximately 320° C. while sensing layer 8 formed on a SUS430 substrate has a Curie point of approximately 380° C., which is a significant increase. Significantly increasing the Curie point of sensing layer 8 provides high heat resistance and high reliability with respect to heat. Accordingly, the device is applicable to a reflow process using lead-free solder essential to surface mounting or the like.

Next, a method of producing the infrared detection device according to this embodiment is described. First, a forming method for the layers composing an infrared detection device is described.

To form intermediate layer 6 on substrate 5, a solution (a precursor solution hereinafter) of a silicon oxide precursor is applied by spin coating to form a silicon oxide precursor film (a precursor film hereinafter). As the precursor solution, a solution primarily containing tetraethoxysilane (TEOS, Si(OC₂H₅)₄) is used. Alternatively, a solution primarily containing other substances such as methyl triethoxysilane (MTES, CH₃Si(OC₂H₅)₃) and perhydropolysilazane (PHPS, SiH₂NH) may be used.

This precursor solution is applied by spin coating onto the main surface of substrate 5 in a state before recess 4 is formed and plate-shaped. Hereafter, the applied film in an uncrystallized state is referred to as a precursor film. The condition for spin coating is 30 seconds at a rotation speed of 2,500 rpm.

Next, the precursor solution is heated at 150° C. for 10 minutes for drying. Drying removes physical adsorption water in the precursor film. The temperature in this case is desirably higher than 100° C. and lower than 200° C. At 200° C. or higher, residual organic components in the silicon oxide precursor film start to decompose. At 100° C. or lower, water may remain in the produced film of intermediate layer 6. Subsequently, the precursor film is heated at 500° C. for 10 minutes to heat-decompose residual organic matters and to compactify the film.

The series of steps from applying the precursor solution onto substrate 5 to compactifying the film are repeated until the precursor film has a desired thickness to form intermediate layer 6. Note that, when the heat treatment is performed at 500° C., iron and chrome as the constituent elements of substrate 5 diffuse to intermediate layer 6. At this moment, using the difference in the diffusion coefficients between iron and chrome produces concentration gradients of iron and chrome in intermediate layer 6. More specifically, chrome diffuses more easily than ion, and thus chrome diffuses to a higher part of intermediate layer 6. Iron has a linear thermal expansion coefficient larger than that of chrome, and thus intermediate layer 6 has a region where the linear thermal expansion coefficient is gradually decreased toward first electrode layer 7 from substrate 5.

Note that, in this embodiment, a silicon oxide layer as intermediate layer 6 is formed by CSD method, but not limited to the method. Any method may be used in which a precursor film of silicon oxide is formed on substrate 5 and the silicon oxide is compactified by heating.

The thickness of intermediate layer 6 is desirably between 300 nm and 950 nm, inclusive. With the film thickness smaller than 300 nm, both iron and chrome constituent elements of substrate 5 may diffuse over entire intermediate layer 6, possibly to first electrode layer 7. If iron and chrome diffuse to first electrode layer 7, the crystallinity of LNO decreases. With a film thickness larger than 950 nm, intermediate layer 6 may cause a crack or the like therein.

Next, an LNO precursor solution for forming first electrode layer 7 is applied onto above-described intermediate layer 6. This LNO precursor solution is prepared as followings.

Lanthanum nitrate hexahydrate (La(NO₃)₃.6H₂O) and nickel acetate tetrahydrate ((CH₃COO)₂Ni.4H₂O) are used as a starting material, and 2-methoxy ethanol and 2-amino ethanol are used as a solvent.

Next, the LNO precursor solution applied onto a surface of substrate 7 is dried at 150° C. for 10 minutes. Drying removes physical adsorption water in the LNO precursor solution. The temperature in this case is desirably higher than 100° C. and lower than 200° C. Drying at this temperature prevents water from remaining in the LNO produced film. At 200° C. or higher, residual organic components in the LNO precursor solution start to decompose.

Subsequently, the dried one is heat-treated at 350° C. for 10 minutes to thermally decompose the residual organic components. The desirable temperature for heat decomposition is 200° C. or higher and lower than 500° C. Heat treatment at this temperature prevents organic components from remaining in the produced LNO precursor film. At 500° C. or higher, the dried LNO precursor is crystallized to a large degree, and thus a lower temperature is desirable.

The series of steps from applying the LNO precursor solution onto intermediate layer 6 to heat-treating the LNO precursor film is repeated until the precursor film has a desired thickness. When the LNO precursor film reaches a desired thickness, the film is rapidly heated using a rapid thermal annealing furnace (referred as an RTA furnace hereafter) to produce and crystallize LNO. On this occasion, heating is performed at 700° C. for 5 minutes. The temperature-rise speed is 200° C. per minute. Note that the heating temperature during crystallization is desirably between 500° C. and 750° C., inclusive. Crystallization of LNO is encouraged at 500° C. or higher, while crystallization of LNO is discouraged at a temperature higher than 750° C.

Subsequently, the crystallized one is cooled to the room temperature. Forming first electrode layer 7 by the above steps provides LNO highly orientated to (100) plane. To make first electrode layer 7 having a desired film thickness, the steps from application to crystallization may be repeated every time instead of collectively crystallizing after repeating the steps from application to thermal decomposition.

Next, a method of producing sensing layer 8 is described. First, a PZT precursor solution is prepared, and then the solution is applied onto first electrode layer 7.

As starting materials for preparing a PZT precursor solution, lead acetate (II) trihydrate (Pb(OCOCH₃)₂.3H₂O), titanium isopropoxide (Ti(OCH(CH₃)₂)₄), and zirconium normal propoxide (Zr(OCH₂CH₂CH₃)₄) are used. These materials are mixed with added ethanol, and the resultant is dissolved, and refluxed to prepare a PZT precursor solution. Ti/Zr ratio is Ti/Zr=70/30 in molar ratio. As a stabilizer, 0.5 mol equivalents of acetylacetone with respect to the total quantity of metal cations are added. Examples of the application method include various types of coating such as dip coating and spray coating, besides spin coating.

After the application is completed, the PZT precursor solution forms a wet PZT precursor film by vaporization of the solvent and hydrolysis. To remove water and a residual solvent contained in the PZT precursor film, the film is dried in a 115° C. drying furnace for 10 minutes. The drying temperature is desirably higher than 100° C. and lower than 200° C. At 200° C. or higher, residual organic components in the PZT precursor solution start decomposing.

Next, in order to decompose organic matters chemically combined to the dried PZT precursor film, pre-firing is performed in a 420° C. electric furnace for 10 minutes. The pre-firing temperature is preferably higher than 200° C. and lower than 500° C. At 500° C. or higher, the dried PZT precursor film is crystallized to a large degree. In this embodiment, the series of steps from applying the PZT precursor solution to pre-firing are repeated three times to form a PZT precursor film. The number of times of repeating is not especially limited.

Subsequently, the PZT precursor film is rapidly heated using an RTA furnace to crystallize the film for producing sensing layer 8. Heating for crystallization is performed at 650° C. for approximately 5 minutes. The temperature-rise speed is 200° C. per minute. For crystallizing first electrode layer 7 and sensing layer 8, an electric furnace, hotplate, IH heating furnace, laser annealing or the like may be used besides an RTA furnace.

Sensing layer 8 formed by the above-described steps has a thickness of approximately 50 nm to 400 nm, and thus when a larger thickness is required, the above steps are repeated. To achieve a desired thickness, the steps of applying the PZT precursor solution to form a PZT precursor film and drying the PZT precursor film are repeated to form the PZT precursor film with a desired thickness, and then a collective crystallization is performed.

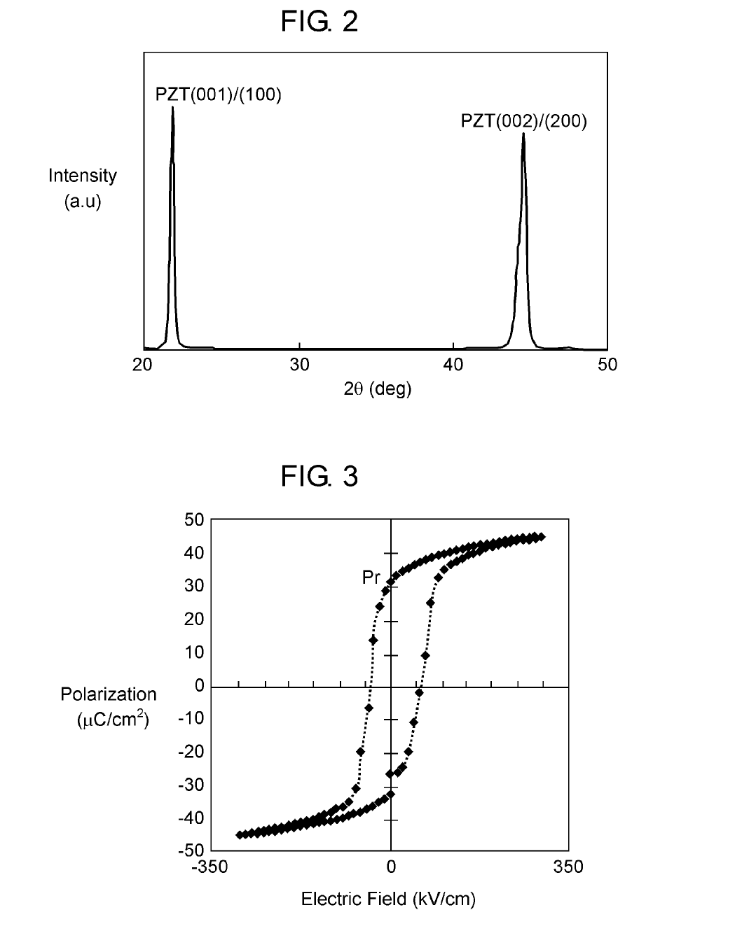

FIG. 2 shows results in which the crystallinity of sensing layer 8 is evaluated using X-ray diffraction method. FIG. 2 proves that sensing layer 8 as a PZT thin film is preferentially oriented to (001) plane.

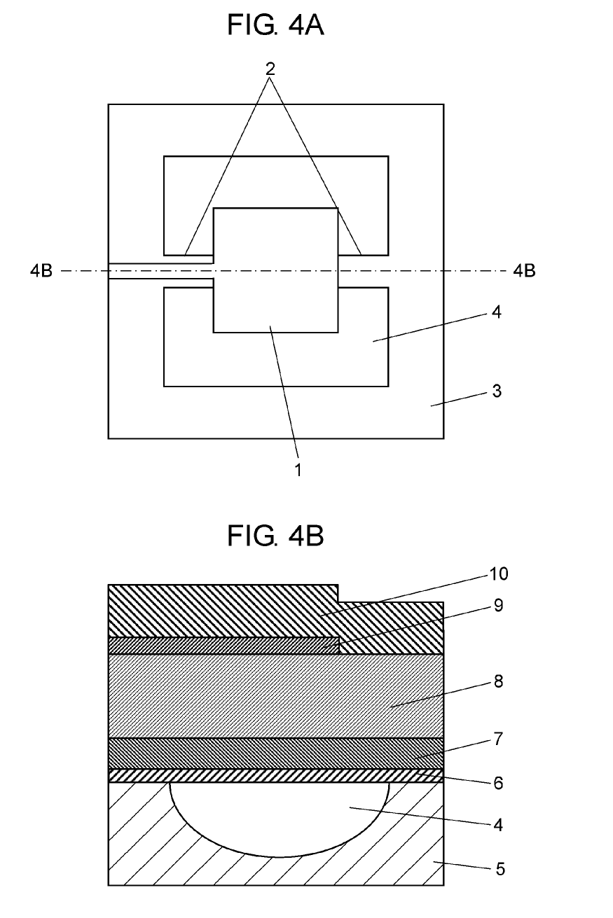

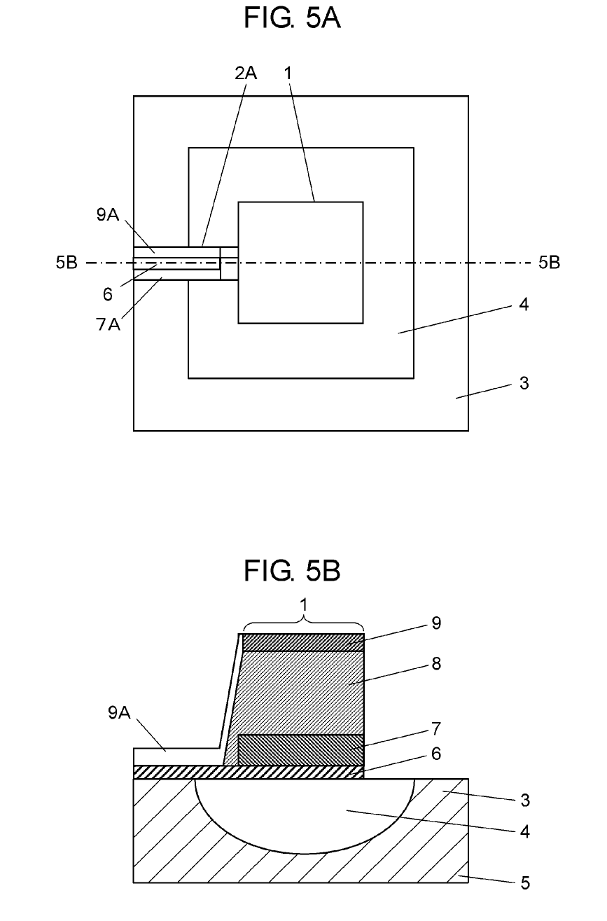

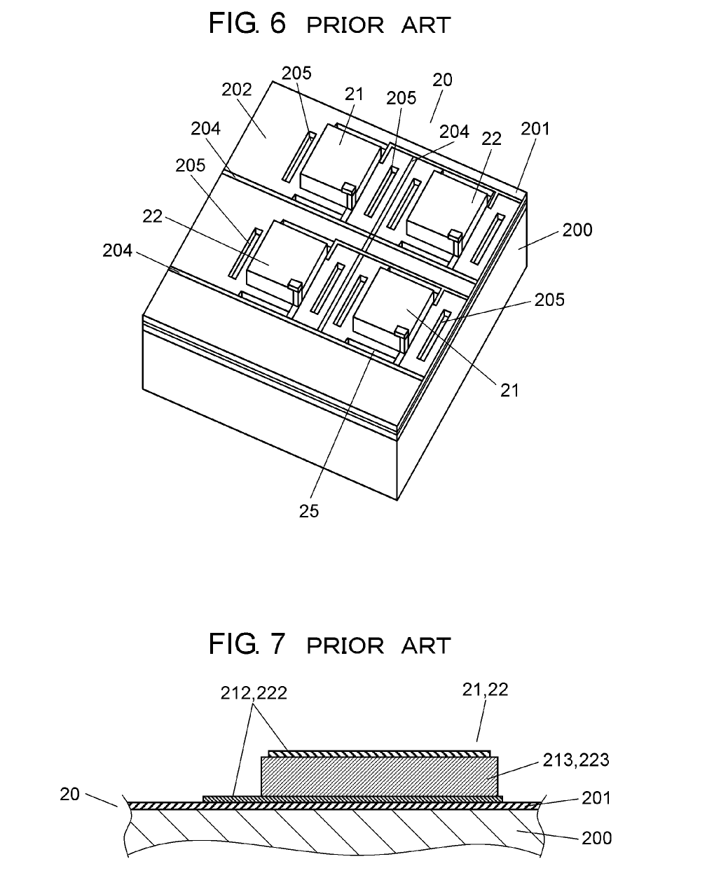

FIG. 2 shows results in which the characteristics (P-E hysteresis loop) of sensing layer 8 is measured. FIG. 3 proves the characteristics of sensing layer 8 provide a favorable, square-type loop and a large remanent polarization value Pr. The pyroelectric coefficient of sensing layer 8 is determined by the change of remanent polarization value Pr according to temperature. To increase a pyroelectric coefficient, a large polarization value is important. Hence, an infrared detection device using sensing layer 8 is expected to provide an infrared detectability higher than a conventional one.

On sensing layer 8 formed by the above-described manufacturing method, second electrode layer 9 made of a nichrome (Ni—Cr) material is formed by using various film-forming methods such as vacuum deposition.

The above steps provide a laminated film in which intermediate layer 6, first electrode layer 7, sensing layer 8, and second electrode layer 9 are formed in this sequence. Next, a method for producing an infrared detection device using this laminated film.

First, second electrode layer 9 is processed by photolithography. A film of resist (not shown) is formed on second electrode layer 9, and then the resist is exposed to ultraviolet rays through a chrome mask or the like with a given pattern. Subsequently, unexposed parts of the resist are removed using a developing liquid to form a resist pattern, followed by dry etching of second electrode layer 9 for patterning. Note that second electrode layer 9 can be patterned by various methods such as wet etching, besides dry etching.

Next, sensing layer 8, first electrode layer 7, and intermediate layer 6 are successively processed. These processes are the same as those of second electrode layer 9, and thus their detailed description is omitted.

After intermediate layer 6 is processed, wet etching is performed from a part where the surface of substrate 5 in the top view is exposed, thereby forming recess 4. In a case where substrate 5 is formed of stainless steel, an iron chloride solution is used for wet etching. Then, wet etching is performed until the back surface of intermediate layer 6 formed at sensing unit 1 and leg 2 is separated from the surface of substrate 5. This procedure provides an infrared detection device with favorable heat insulation.

In intermediate layer 6, the ratio of the diffusion amount of iron and that of chrome are inclined from substrate 5 toward first electrode layer 7 as described above. Intermediate layer 6 has a larger linear thermal expansion coefficient near substrate 5 where intermediate layer 6 has a higher ratio of the amount of iron, and the linear thermal expansion coefficient is decreased toward first electrode layer 7. This prevents warpage of intermediate layer 6 due to thermal stress resulting from the difference between the linear thermal expansion coefficients of stainless steel and silicon oxide. Accordingly, even in a state where intermediate layer 6 is separated from the surface of substrate 5, warpage and destruction of sensing unit 1 and leg 2 can be prevented.

Sensing layer 8 made of PZT is formed on first electrode layer 7 made of LNO. Accordingly, remarkably higher crystal orientation is achieved as compared to a case where a sensing layer is formed on a Pt electrode as in a conventional infrared detection device.

According to this embodiment, intermediate layer 6, first electrode layer 7, and sensing layer 8 are formed by CSD method, which eliminates the need for vacuum process that is required in vapor phase growth such as sputtering, thereby reducing the cost. Further, forming LNO used for first electrode layer 7 by the producing method of this embodiment allows the LNO to be self-oriented to (100) plane. Therefore, the orientation direction is hardly dependent on the material of substrate 5. Accordingly, there is no restriction on the material of substrate 5.

Using a metallic material (e.g., a stainless-steel material) or the like that reflects infrared rays for substrate 5 allows infrared rays that have transmitted through sensing unit 1 to be reflected and enter heat-type light sensing element 11 again. Therefore, the amount of infrared rays converted to heat can be increased, thereby raising the infrared detectability. Further, a stainless-steel material is much cheaper than a silicon substrate, which advantageously reduces the cost of substrates by about one digit.

When etching substrate 5, wet etching is employed, and thus etching proceeds isotropically from the surface of substrate 5. Hence, recess 4 after being processed is arc-shaped viewed from the cross sectional direction as shown in FIG. 1B. Accordingly, the etched bottom surface acts on infrared rays that have transmitted through sensing unit 1 like a concave mirror. This allows efficiently collecting light not only from above second electrode layer 9 but from under intermediate layer 6, that is, from under the back surface.

Further, it is preferable that the stainless steel material of substrate 5 is a stainless steel strip (a rolled steel plate) that has undergone rolling; and the stainless steel strip is formed of an aggregate of metal particles (the metallic structure) with a particle diameter smaller than the diameter or the length of the short side of sensing layer 8. Using such a material for substrate 5 causes the etching liquid for wet etching to penetrate through the grain boundaries of metal particles (the metallic structure). Consequently, etching of substrate 5 is accelerated at the position under sensing layer 8 shown in the sectional view of FIG. 1B from the direction perpendicular to the cross section. Accordingly, the speed of etching substrate 5 is increased, thereby eventually shortening the production time of infrared detection devices. Note that, when a stainless steel strip with a diameter of metal particles (the metallic structure) smaller than the external diameter or half the length of the short side of sensing layer 8 is used, the cross section of substrate 5 parallel to the outer circumferential surface of sensing layer 8 has at least one metal grain boundary. Accordingly, etching is accelerated from the direction perpendicular to the cross section of substrate 5. The diameter of metal particles of the stainless steel strip that has undergone rolling is approximately 20 μm to 30 μm, which satisfies the above condition if sensing layer 8 is designed so that the length of the short side (one side) is approximately 60 μm or larger.

If the surface of substrate 5 is exposed to a small degree when etching substrate 5, an etching hole (not shown) may be formed inside sensing unit 1 so as to penetrate through intermediate layer 6, first electrode layer 7, sensing layer 8, and second electrode layer 9. This allows wet etching from the inside of sensing unit 1 as well, thereby shortening the etching time.

Next, another infrared detection device according to the embodiment is described referring to FIGS. 4A and 4B. Note that components same as those of the infrared detection device shown in FIGS. 1A and 1B are simply described, and differences are described in detail. FIG. 4A is a top view of the infrared detection device. FIG. 4B is a sectional view of the infrared detection device of FIG. 4A, taken along line 4B-4B.

This infrared detection device has constrained layer 10 formed on sensing layer 8 and second electrode layer 9 of the infrared detection device shown in FIGS. 1A and 1B for further increasing infrared detectability.

It is preferable that constrained layer 10 has a linear thermal expansion coefficient smaller than that of sensing layer 8 and is formed of a material capable of absorbing infrared rays. In this embodiment, a material primarily containing silicon oxide is used therefor. Note that the material of constrained layer 10 is not limited to silicon oxide, but any material capable of absorbing infrared rays may be used, such as a silicon oxynitride film (SiON) produced by nitriding silicon oxide; and a silicon nitride film (SiN).

Forming constrained layer 10 prevents a compressive stress applied to sensing layer 8 from being released when wet etching is performed from the surface of substrate 5, recess 4 is formed, and sensing layer 8 is separated from substrate 5. Constrained layer 10 has a linear thermal expansion coefficient smaller than that of sensing layer 8, and thus is subjected to a stress in a relatively tensile direction as compared to sensing layer 8. More specifically, when sensing layer 8 is separated from substrate 5, sensing layer 8 subjected to a stress in the compressive direction undergoes a force in the tensile direction that releases the stress, while constrained layer 10 formed on sensing layer 8 undergoes a force in the compressive direction that is relatively reverse as compared to sensing layer 8. Accordingly, the release of the stress on sensing layer 8 is suppressed. This maintains high polarization characteristics of sensing layer 8 while preventing the Curie point raised by the compressive stress from lowering.

Further, constrained layer 10 has infrared absorption ability, and thus can efficiently convert the received infrared rays to heat, thereby providing high infrared detectability. Furthermore, forming second electrode layer 9 from a material, that reflects infrared rays, such as gold and platinum, allows infrared rays that have once transmitted through constrained layer 10 to reflect on second electrode layer 9 and be absorbed again in constrained layer 10. Therefore, higher infrared absorption ability and eventually higher infrared detectability are achieved.

Moreover, it is preferable that expression (1) is satisfied where “d” and “n” are the thickness and the refractive index of constrained layer 10, respectively, “λ” is the wavelength of the infrared rays as a detection target, and “m” is 0 or a natural number. In this case, infrared rays that have come in interfere with infrared rays that have reflected on second electrode layer 9, thereby providing higher infrared absorption ability and thus higher infrared detectability.

n×d=(2m+1)×λ/4 (1)

Note that the infrared detection device shown in FIG. 1A or 4A has two legs 2; however, at least one leg 2 is adequate. The infrared detection device shown in FIG. 1B or 4B has sensing layer 8 formed throughout the total length of one of legs 2; however, sensing layer 8 has only to be provided in sensing unit 1 and is not required in leg 2 functionally. FIGS. 5A and. 5B are a top view and a sectional view of an infrared detection device with such a structure, respectively.

As shown in FIG. 5A, in this infrared detection device, sensing unit 1 is supported over recess 4 with single leg 2A. As shown in FIG. 5B, only sensing unit 1 has sensing layer 8 formed therein. Then, first lead 7A extending from first electrode layer 7 and second lead 9A extending from second electrode layer 9 lie parallel to each other on leg 2A formed substantially of intermediate layer 6. Even such a structure provides the same advantages as those of the infrared detection device shown in FIGS. 1A and 1B. With respect to strength, however, two or more legs are preferred, and in view of easiness of production, sensing layer 8 is preferably formed also in the legs.

### INDUSTRIAL APPLICABILITY

As described above, an infrared detection device according to the present invention has high pyroelectric characteristics, infrared absorption ability, and heat insulation. Accordingly, the infrared detection device provides superior sensor characteristics with high infrared detectability. This infrared detection device used for electronic devices provides various types of devices with high infrared detectability, such as an infrared sensor. Hence, this infrared detection device is useful for sensors such as a motion sensor and a temperature sensor, and power generation device such as a pyroelectric power generation device.

### REFERENCE MARKS IN THE DRAWINGS

1 Sensing unit
2, 2A Leg
3 Frame
4 Recess
5 Substrate
6 Intermediate layer
7 First electrode layer
7A First lead
8 Sensing layer
9 Second electrode layer
9A Second lead
10 Constrained layer
11 Heat-type light sensing element

1. An infrared detection device comprising:
a substrate provided with a recess and including a frame positioned around the recess; and
a heat-type light sensing element including a sensing unit and a leg connected onto the frame so that the sensor unit is positioned over the recess, the heat-type light sensing element also including an intermediate layer provided on the substrate, a first electrode layer provided on the intermediate layer, a sensing layer provided on the first electrode layer, and a second electrode layer provided on the sensing layer,
wherein the substrate has a linear thermal expansion coefficient larger than a linear thermal expansion coefficient of the sensing layer, and
wherein the intermediate layer has a linear thermal expansion coefficient decreasing toward the first electrode layer from the substrate.

2. The infrared detection device according to claim 1,
wherein one of a polarization amount and capacitance of the sensing layer changes according to temperature change.

3. The infrared detection device according to claim 1,
wherein the substrate is formed of a material capable of reflecting infrared rays.

4. The infrared detection device according to claim 3,
wherein the substrate is formed of a metallic material.

5. The infrared detection device according to claim 4,
wherein the substrate is formed of a rolled steel plate having a minute metallic structure, and
wherein the metallic structure has a diameter smaller than a diameter of the sensing layer that is circular in a top view, and has a diameter smaller than a length of a short side of the sensing layer that is square in a top view.

6. The infrared detection device according to claim 1,
wherein two or more elements contained in the substrate diffuse in the intermediate layer.

7. The infrared detection device according to claim 6,
wherein the intermediate layer has gradients of diffusion amounts of the two or more elements contained in the substrate, the gradients being different from each other.

8. The infrared detection device according to claim 7,
wherein the substrate is formed of a metallic material containing iron and chrome, and
wherein the intermediate layer is formed by diffusion of iron and chrome contained in the substrate.

9. The infrared detection device according to claim 6,
wherein the intermediate layer is formed of silicon oxide.

10. The infrared detection device according to claim 1,
wherein the heat-type light sensing element is provided on the second electrode layer and further has a constrained layer with a linear thermal expansion coefficient smaller than the linear thermal expansion coefficient of the sensing layer.

11. The infrared detection device according to claim 10,
wherein the constrained layer is formed a material capable of absorbing infrared rays, and
wherein the second electrode layer is formed a material capable of reflecting infrared rays.

12. The infrared detection device according to claim 11,
wherein expression (1) is satisfied where “d” is a thickness of the constrained layer, “n” is a refractive index of the constrained layer, “λ” is a wavelength of infrared rays as a detection target, and “m” is 0 or a natural number.
n×d=(2m+1)×λ/4 (1)

13. The infrared detection device according to claim 1,
wherein the second electrode layer is formed of a material capable of absorbing infrared rays.

14. The infrared detection device according to claim 1,
wherein the first electrode layer is formed of a perovskite oxide having electric conductivity, and
wherein a ratio of a difference between a lattice constant of a main orientation plane of the first electrode layer and a lattice constant of a main orientation plane of the sensing layer, with respect to the lattice constant of the main orientation plane of the sensing layer falls within ±10%.
